(19) United States
(12) Patent Application Publication
(10) Pub. No.: US 2011/0184684 A1
(43) Pub. Date: Jul. 28, 2011

(54) 3-D SELF-CORRECTING FREEHAND ULTRASOUND TRACKING SYSTEM

(75) Inventors: Lu Li, Sunnyvale, CA (US); Animesh Khemka, San Jose, CA (US)

(73) Assignee: EIGEN, INC., Grass Valley, CA (US)

(21) Appl. No.: 13/041,990

(22) Filed: Mar. 7, 2011

Related U.S. Application Data
(63) Continuation-in-part of application No. 12/840,987, filed on Jul. 21, 2010, now abandoned.
(60) Provisional application No. 61/227,274, filed on Jul. 21, 2009.

(51) Int. Cl. G06F 19/00

(52) U.S. Cl. 702/94

(57) ABSTRACT

This application presents a new system and method for image acquisition of internal human tissue, including but not limited to the prostate, as well as a system and method for the guidance and positioning of medical devices relative to the internal tissue. In the presented systems and methods, ultrasound scanned data (e.g., 2-D B-mode images) are acquired freehand absent a mechanical armature that constrains an ultrasound acquisition probe in a known spatial framework. To allow for reconstruction of the scanned data into a 3-D image, multiple tracker sensors that provide position/location information are used with a freehand acquisition probe (e.g., handheld ultrasound probe). The position of such tracker sensors can be calculated when disposed in an electromagnetic field.

### CROSS-REFERENCE TO RELATED APPLICATION

This application is a continuation in part of U.S. patent application Ser. No. 12/840,987 filed on Jul. 21, 2010 and which claims the benefit of filing date of U.S. Provisional Application No. 61/227,274 entitled: “3-D Self-Correcting Freehand Ultrasound Tracking System” and having a filing date of Jul. 21, 2009, the entire contents of both of which are incorporated herein by reference.

### FIELD

The present disclosure pertains to the field of medical imaging, and more particular to the registration of arbitrarily aligned 2-D images to allow for the generation/reconstruction of a 3-D image/volume.

### BACKGROUND

Medical imaging, including X-ray, magnetic resonance (MR), computed tomography (CT), ultrasound, and various combinations of these and other image acquisition modalities are utilized to provide images of internal patient structure for diagnostic purposes as well as for interventional procedures. Often, it is desirable to utilize multiple two-dimensional (i.e. 2-D) images to generate (e.g., reconstruct) a three-dimensional (i.e., 3-D) image of an internal structure of interest.

2-D image to 3-D image reconstruction has been used for a number of image acquisition modalities (such as MRI, CT, Ultrasound) and image based/guided procedures. These images may be acquired as a number of parallel 2-D image slices/planes or rotational slices/planes, which are then combined together to reconstruct a 3-D image volume. Generally, the movement of the imaging device has to be constrained such that only a single degree of freedom is allowed (e.g., rotational movement). This single degree of freedom may be rotation of the imaging device or a linear motion of the imaging device. During such a procedure, the presence any other type of movement will typically cause the registration of 2-D images in 3-D space to be inaccurate.

This presents difficulties in handheld image acquisition where rigidly constraining movement of an imaging device to a single degree of freedom is difficult if not impossible. Further constraining an imaging device to a single degree of freedom may also limit the image information that may be acquired. This is true for handheld, automated and semi-automated image acquisition. Depending upon the constraints of the image acquisition methods, this may limit use or functionality of the acquisition system for 3-D image generation.

### SUMMARY

This application presents a new system and method for image acquisition of internal human tissue, including but not limited to the prostate, as well as a system and method for the guidance and positioning of medical devices relative to the internal tissue. In the presented systems and methods, ultrasound scanned data (e.g., 2-D B-mode images) are acquired freehand absent a mechanical armature that constrains an ultrasound acquisition probe in a known spatial framework. To allow for reconstruction of the scanned data into a 3-D image, multiple tracker sensors that provide position/location information are used with a freehand acquisition probe (e.g., handheld ultrasound probe). The position of such tracker sensors can be calculated when disposed in an electromagnetic field.

However, the orientation of the image plane of the acquisition probe relative to the tracker sensor must be calibrated. That is, the probe is calibrated so pixels in acquired 2D images can be mapped to their 3D coordinates (e.g., within an image cube). The validation of the calibration is performed to confirm the accuracy of the tracking. Additional tracker sensors may be used for the correction of target object movement.

A novel interpolation method is also utilized in the freehand tracking system to reconstruct the internal tissue object from the input data. In such an arrangement, the free hand tracking system takes an average of the tracking data and the corrects the data with information from one or multiple sensors to improve the accuracy of the tracking and the target location inside the scanned image cube as displayed. The needle trajectory can be also monitored by the multiple sensor strategy.

### BRIEF DESCRIPTION OF THE FIGURES

FIG. 1 illustrates a medical imaging system utilized for ultrasound imaging.

FIGS. 2A and 2B illustrate acquisition of medical images having a single degree of freedom.

FIG. 3 illustrates arbitrarily aligned 2-D images acquired by freehand scanning.

FIG. 4a illustrates an ultrasound probe incorporating a tracker sensor.

FIG. 4b illustrates an ultrasound probe incorporating a tracker sensor.

FIG. 5 illustrates a 2-D image plane of the probe

FIG. 6 illustrates position of image planes in 3-D space.

FIG. 7 illustrates averaging of the sensor and images of the probe.

FIG. 8 illustrates the process of an overview of the Tracking system.

FIG. 9 illustrates the process of a Calibration and Validation System.

FIG. 10 illustrates the process of a Needle calibration and validation.

FIG. 11 illustrates the process of a Calibration System.

FIG. 12 illustrates the process of a Validation System.

FIG. 13 illustrates the process of a Scanning System.

FIG. 14 illustrates the process of an Interpolation System.

FIG. 15 illustrates the process of Tracking and Display.

FIG. 16 illustrates the process of Synchronizing and Correction

### DETAILED DESCRIPTION

Reference will now be made to the accompanying drawings, which assist in illustrating the various pertinent features of the present disclosure. Although the present disclosure is described primarily in conjunction with transrectal ultrasound imaging for prostate imaging, it should be expressly understood that aspects of the present invention may be applicable to other medical imaging applications. In this regard, the following description is presented for purposes of illustration and description.

As presented, the invention is directed towards systems and methods for interpolation and reconstruction of a 3-D image from 2-D image planes/frames/slices obtained in arbitrary orientation during, for example, an unconstrained scan procedure. Also included is a method for improving interpolation.

The reconstruction method pertains to all types of 2-D image acquisition methods under various modalities and specifically for 2-D image acquisition methods used while performing an image-guided diagnostic or surgical procedure. It will be appreciated that such procedures include, but are not limited to, ultrasound guided biopsy of various organs, such as prostate (trans-rectal and trans-perineal), liver, kidney, breast, etc., brachytherapy, ultrasound guided laparoscopy, ultrasound guided surgery or an image-guided drug delivery procedures.

Most current methods for reconstructing a 3-D image from 2-D image planes assume some type of uniformity (e.g., constraint) in image acquisition. For example, most previous methods assume (or require) that the 2-D images be obtained as parallel slices or are displaced from each other through an angle while meeting at one fixed axis. The presented system and method alleviates the need for contrast between 2-D images while permitting the images to be disposed in a common 3-D Frame of Reference and/or utilized to generate 3-D images.

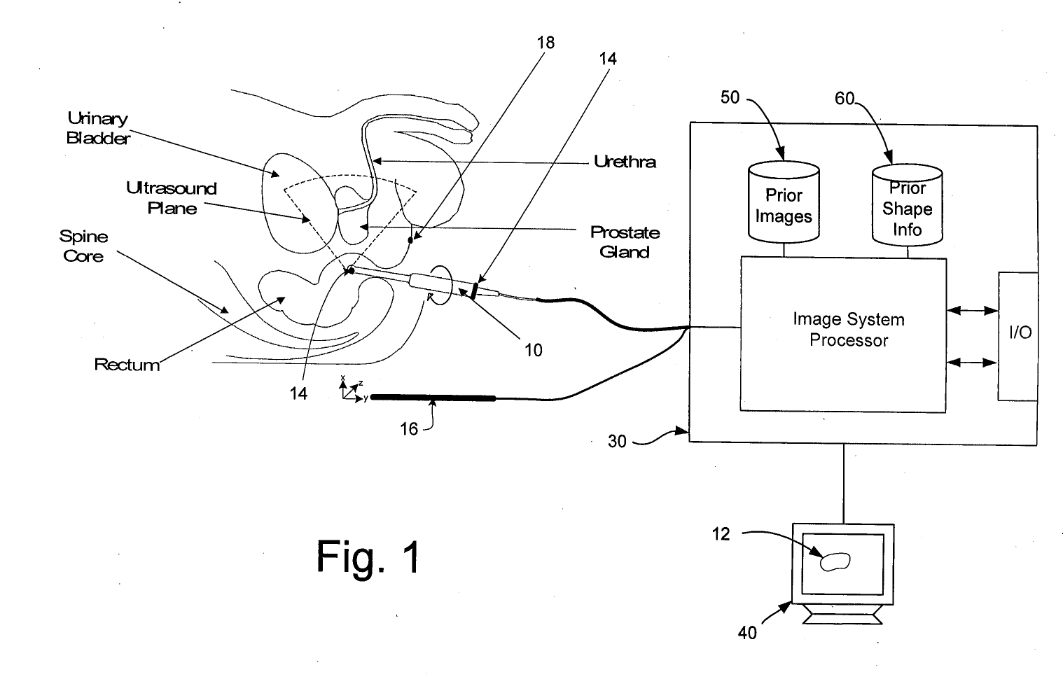

FIG. 1 illustrates a transrectal ultrasound probe 10 that may be utilized to obtain a plurality of two-dimensional ultrasound images of the prostate 12. As shown, the probe 10 may be operative to scan an area of interest. The probe 10 may also include a biopsy gun that may be attached to the probe. Such a biopsy gun may include a spring driven needle that is operative to obtain a core from desired area within the prostate and/or deliver medicine to a location within the prostate.

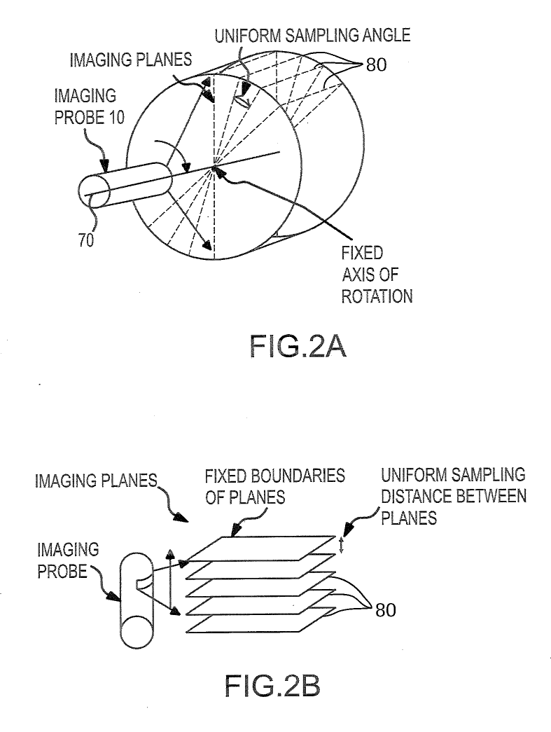

In automated arrangements, the probe may be affixed to a positioning device (not shown) and a motor may sweep the transducer of the ultrasound probe 10 over a radial area of interest (e.g., around a fixed axis 70; see FIG. 2A). Accordingly, the probe 10 may acquire plurality of individual images 80 while being rotated through the area of interest. Each of these individual image slices 80 may be represented as a two-dimensional image. Alternately, the probe 10 may be linearly advanced to obtain a plurality of uniformly spaced images as illustrated in FIG. 2B. In both instances, the resulting 2-D image sets may be registered to generate a three-dimensional image. In order to generate a highly accurate 3-D reconstruction, previous interpolation techniques have typically depended heavily on the tolerances on deviation from the assumptions (i.e., that all images are fixed except for a single degree of freedom). However, it is often desirable to utilize a handheld probe to acquire images, for example, just prior to performing a procedure.

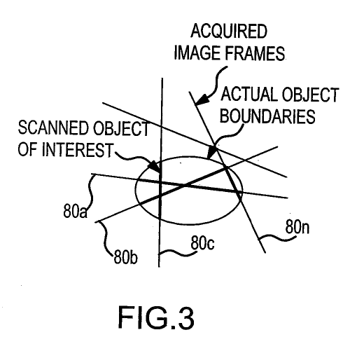

Such handheld acquisition, however, often introduces multiple degrees of freedom into the acquired 2-D images. For example, FIG. 3 illustrates a plurality of 2-D images 80a-n acquired for an object of interest (e.g., prostate) where the images are not aligned to any common axis. In this method, 2-D images are obtained in an unconstrained fashion (e.g., using handheld imaging devices) while the imaging device is manipulated to scan the object. The user may scan the object in a freehand fashion in various different orientations. To align these images 80a-n in a common frame of reference, the orientation and location of the imaging planes 80a-n are measured using a magnetic tracker 14 that is affixed to the probe 10. See FIG. 1. The position of the tracker 14 is recorded in relation to a known reference by a reading device 16 (e.g. an electromagnetic field generator), which outputs location information of the tracker 14 to an imaging system 30 that also receives images from the imaging device 10.

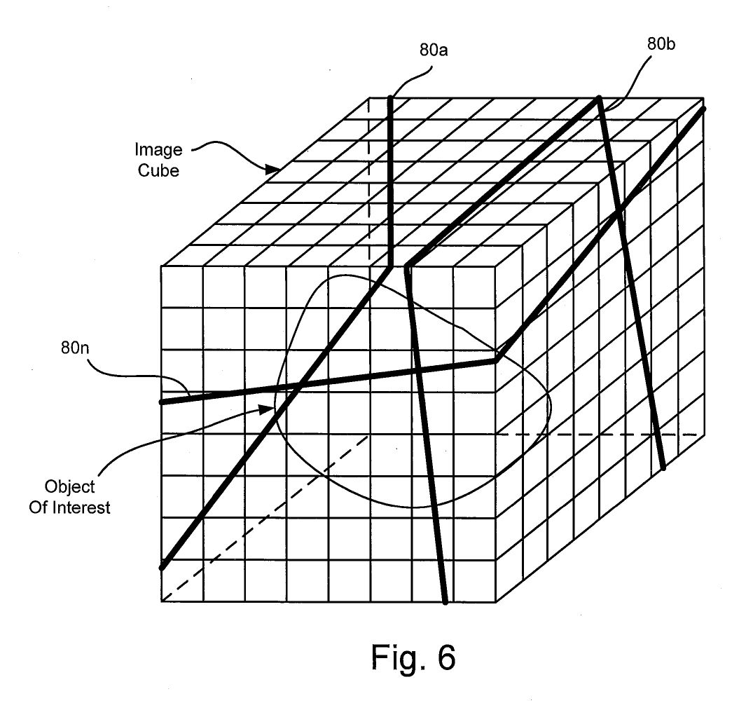

The imaging system 30 is operative to correlate the recorded 3-D position of the tracker-14 and a corresponding image acquired by the probe 10. As will be discussed herein, this allows for utilizing non-aligned/arbitrary images for 3-D image reconstruction. That is, the imaging system 30 utilizes the acquired 2-D images 80a-n to populate the 3-D image volume 12 or image cube as per their measured-3-D locations. See also FIG. 6. In addition to reconstructing the 3-D volume after images are acquired, the method also allows for dynamic refinement at desired regions. That is, a user may acquire additional images at desired locations and the reconstruction method interpolates the additional information into the 3-D volume.

The imaging system includes a computer or is interconnected to a computer system that runs application software and computer programs, which can be used to control the system components, provide user interface, and provide the features of the imaging system. The software may be originally provided on computer-readable media, such as compact disks (CDs), magnetic tape, or other mass storage medium. Alternatively, the software may be downloaded from electronic links such as a host or vendor website. The software is installed onto the computer system hard drive and/or electronic memory, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having computer-readable program code embodied therein. The software contains one or more programming modules, subroutines, computer links, and compilations of executable code, which perform the functions of the imaging system. The user interacts with the software via keyboard, mouse, voice recognition, and other user-interface devices (e.g., user I/O devices) connected to the computer system.

While use of a tracker 14 in conjunction with the probe 10 allows roughly aligning separate ultrasound 2-D images in a 3-D frame of reference or image cube, the orientation of the image plane 80 of the acquisition probe relative to the tracker sensor must be calibrated. That is, the image plane 80 of the probe and the tracker 14 must be calibrated so pixels in acquired 2D images can be accurately mapped to their 3D coordinates (e.g., global coordinates). The validation of the calibration is performed to confirm the accuracy of the tracking. Additional tracker sensors may be used for the correction of target object movement.

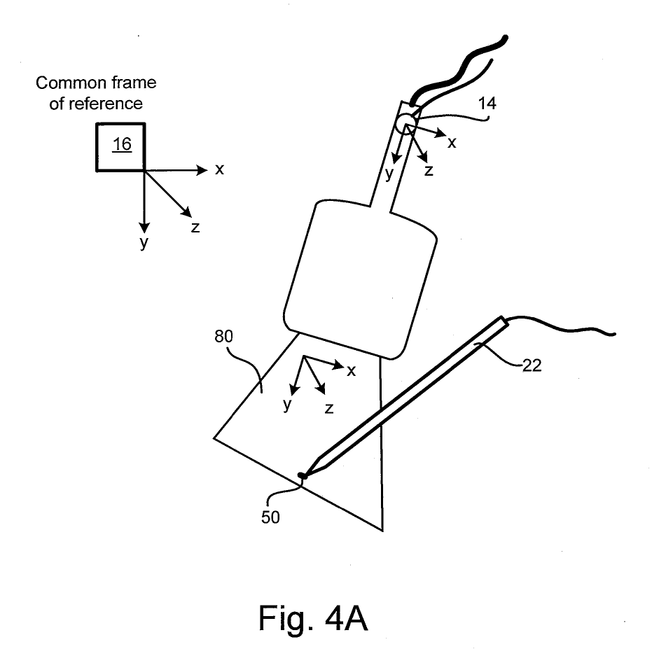

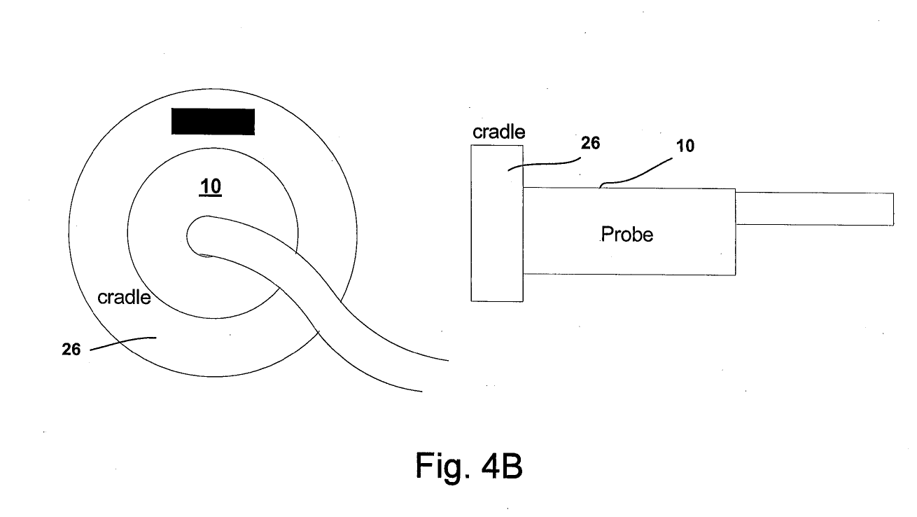

FIG. 4A, illustrates another embodiment of an acquisition probe 10, which may be utilized for imaging on the surface of patient tissue. The arrangement of FIG. 4A, illustrates an image plane 80 of the probe 10, a first tracker sensor 14 (6 degrees of freedom DOF) and the use of a second tracker 22 (e.g. need tracker) to calibrate they system, as is further discussed herein. As shown in FIG. 4B, the tracker sensor 14 (e.g., coil) is embedded into a cradle 26 that is attached to a base of the probe 10. It will be appreciated that the exact location, orientation and connection mechanism used to attach the sensor 14 is unimportant so long as the sensor is maintained in a fixed relationship with the probe 10. The tracker system returns the translational position of the sensor 14 relative to a coordinate system fixed at a certain location, i.e. center of the field generator for an electromagnetic tracking device 16. The use of the multiple DOF sensor also allows returning the orientation of the sensor. From the translational and orientation information, a four by four homogenous transformation matrix can be constructed, as further discussed herein.

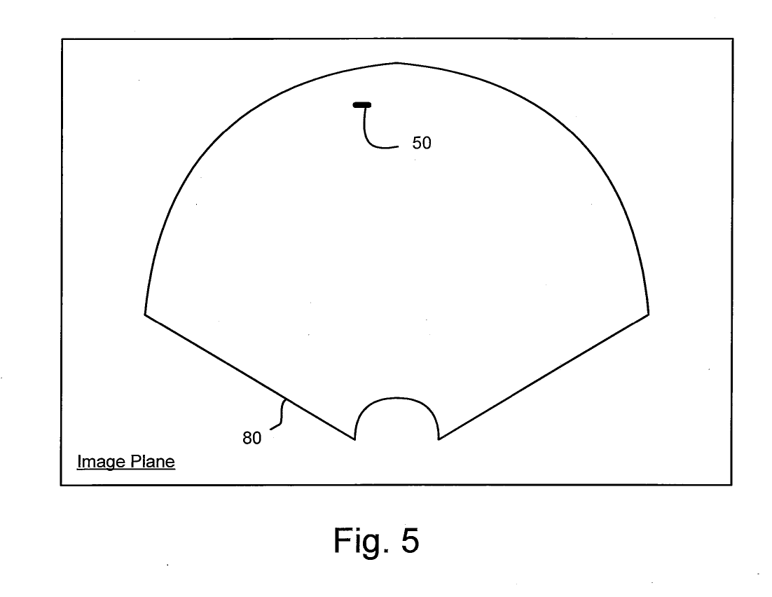

To calibrate the probe, the probe is used to image a known location, which in the embodiment of FIG. 4A is a calibration point 50. Such a calibration point 50 is usually located in or on a pre-fabricated phantom with known geometry (including bead, string, surfaces or volumes). Initially, a user moves the ultrasound probe 10 to calibration/target point of the phantom, making sure that the target point 50 is in the 2D imaging plane 80. See FIG. 5. The ultrasound probe 10 is then fixed in this position and the 2D coordinates (u, v) of the image plane are saved. At this time, a user moves a tracker needle/pointer 22 to the physical target point. This tracker pointer 22 provides the coordinates of the target point which is fixed in the image plane 80 of the probe 10. The readings from the tracker pointer are saved. The position of the target point can then be determined in the ultrasound image, Pᵤₛ, using a calibration matrix T_{c}, and the reference tracker's transformation matrix, T_{ref}, using the following equation:

P_{tip/ref}=T_{ref}⁻¹·Pₜᵢₚ=T_{c}·Pᵤₛ=T_{c}·(u,v,0,1)^{T} (1)

Where P_{tip/ref} is a vector. For every measurement of the target point by the tracker needle/pointer, measurement data and averaged measurement data is used. After taking n measurements, the equation (1) will become:

$${P}_{tip / ref , 1} , … {P}_{tip / ref , n} = {T}_{c} \cdot [ \begin{matrix}{u}_{1} & {u}_{n} \\ {v}_{1} & {v}_{n} \\ 0 & 0 \\ 1 & 1\end{matrix} ] = {T}_{c} \cdot {P}_{us} \qquad ( 2 )$$

The calibration matrix is calculated by SVD solution using:

T_{c}=(P_{tip/ref,1}, . . . P_{tip/ref,n})·Tᵤₛ^{T}·(Tᵤₛ·Tᵤₛ^{T})⁻¹ (3)

Similar calibration can be done if a relative position of a feature is known. At this point, the relationship between the tracker 14 attached to the probe and the image plane is known and the 2D images acquired by the probe may be inserted into a common frame of reference (e.g., an image cube)

### Validation of the Calibration:

It is important to validate the calibration, since it confirms the calibration matrix computed will accurately reconstruct the 2D plane in the tracking space. The setup of the validation is similar to that of the calibration. Again a target point, such as a string phantom, bead, surface, volume etc. and the extra tracker pointer are used for the validation. The validation includes moving the ultrasound probe to the string phantom, making sure that the string crossing point is at the imaging plane. The probe is again fixed and the 2D coordinates (u, v) are saved. Calculating the location of the pixel:

$${P}_{tim / ref = {T}_{c}} [ \begin{matrix}u \\ v \\ 0 \\ 1\end{matrix} ] \qquad ( 4 )$$

The tracker pointer is moved to a known point (e.g., a string crossing point in a phantom) and the readings from the tracker pointer P_{act} are saved. The error between the original calibration and the validation is then calculated:

E=|P_{tim/ref}−P_{act}| (5)

The calibrated and validated probe may now be used to acquire images in its frame of reference. That is, the phantom may be removed and a patient may be located within the frame of reference for image acquisition.

During scanning a user can select a patient region of interest to define the 3D image volume he wants to scan. During the scanning, a 2D series of image planes 80 acquired by the probe will be displayed into the 3D volume with certain transparency, and so the user can be aware of how scanning is progressing. That is, if an area of the image volume is not covered, the user may reposition to the probe to acquire data for that area. See. FIG. 6. As shown, as separate image planes (e.g. 2D images) are acquired, they may be transformed into a common frame of reference and populate an image/image cube. If enough images are acquired, data from the images may be combined to generate a 3D image.

### 3D Image Acquisition:

There are three major scanning methods for 3D B-scan ultrasound systems. The first is rotary scanning in 2D planes with equal angles. The second is the linear scan. The third is freehand scanning with 2D US transducer. In the first situation the positions and values are measured in polar coordinates on the planes with equal angles. In the second and third situation the positions and values are measured on the polar coordinates on the planes with random gaps and directions. For the rotary scanning, if the angle between two scan is taken small enough, e.g. 1 degree, the volume of interest (e.g., image are or cube) can be totally covered (See FIG. 2A). Similarly, complete data can be acquired in a parallel manner (See FIG. 2B).

For the freehand scanning, if the acquired 2D image planes 80 cover 90% of the 3D image area or cube, (See FIG. 6), the 3D image generation can be done by simple nearest neighbor interpolation. Otherwise if there are regions in the image cube that cannot or are not acquired in the freehand scanned data, a more robust interpolation process is needed to reconstruct object in the image cube. The difficulty of the interpolation for the freehand scanning compared to rotary scanning or parallel scanning is that the data is required to be filled to the volume of interest and that non-uniform gaps exist between the acquired data. The reconstructed image is also required to meet the requirements for the sharpness at the image edge and the requirements for the smoothness of the image itself. In the present approach, an Expectation Maximization (EM) technique with a diffusion filter is applied. Such a method is set forth in co-pending U.S. patent application Ser. No. 12/695,822 having a filling date of Jan. 28, 2010, the entire contents of which are incorporated herein by reference.

### 3D Image Tracking.

In many instances, it is desirable to track a desired position within an object of interest. For instance, performing a biopsy may require that a biopsy device be guided to a desired location within the object. Accordingly, the generated 3D image of such an object may be is used for such tracking. If the object of interest is not moving, tracking relates the current live scanning from the ultrasound image to the scanned image so as to confirm that certain/desired location inside the object is reached. To perform such tracking, the system must calculate the destination location using the transformation matrix and display the region for tracking in the scanned cube.

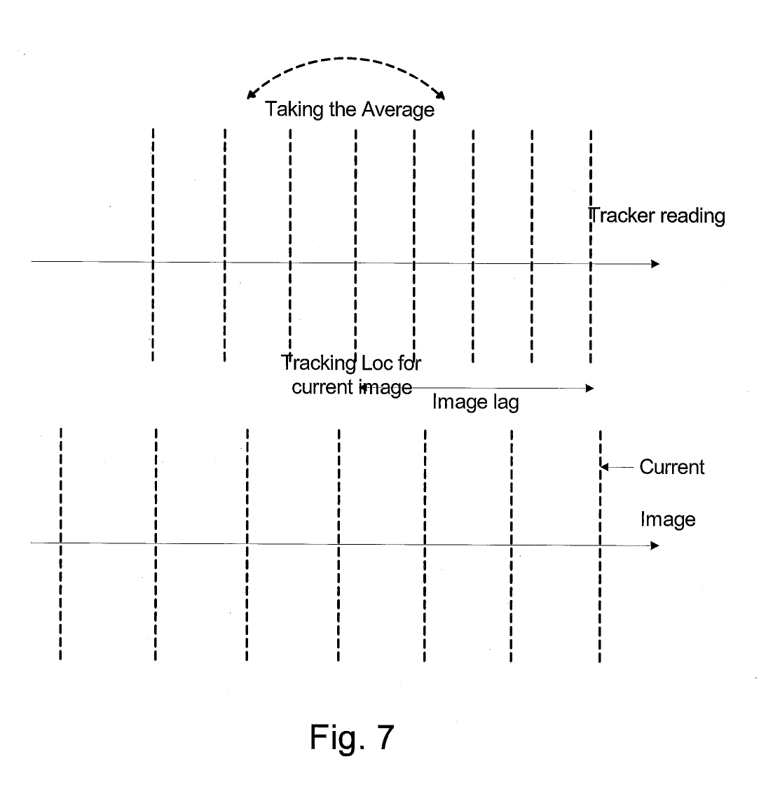

To provide improved real-time tracking, it may be necessary to synchronize the 2D input image and the reading of the tracker. The readings of the tracker and the images are graphically shown in FIG. 7. The upper one is for the tracker reading timing and the lower one is the image reading timing. For the image reading, there is typically a lag of, for example, 140 ms. So if it is desired to synchronize the tracker reading and the image reading, the lag must be considered. Of note, the tracker reader and image reading timing often have different frequencies. Accordingly, it may be desirable to average several reading for each to reduce the time difference between these readings.

### Self-Correction Strategy:

In the real world applications it is very common that the patient moves during scanning or navigating, which could create significant error. The present system uses a novel approach to apply a movement correction. More specifically, an additional sensor(s) is provided that outputs patient movement information. That is, another tracker sensor 18 is attached to the patient/target object which reports the movement of the patient. See. FIG. 1

In the scanning phase, once the user begins scanning, the volume around the home position of the probe is filled by the contiguous 2D ultrasound images. The location of the tracker, which attached to the patient, is Pₚₐₜ, and the rotation matrix is Tₚₐₜ. Since the location and rotation of the patient tracker sensor 18 is continuously read, if the patient moves during the procedure, the displacement of the tracker is determined and the transformation matrix Tₚₐₜ can be obtained. In the reconstruction strategy, the location of the 2D image will be corrected as:

P_{new}=T_{c}·Tₚₐₜ·Pᵤₛ (6)

where Pᵤₛ is the locations of the pixels in the live image, and T_{c} is the calibrated transformation matrix. That is, if the tracker position/rotation changes it can be detected by the system, and the self-correction will be applied for the whole volume. Similarly, if the movement happens in the tracking phase, the self-correction can happen so the error can be reduced. Further more, multiple sensors can be attached to the patient so the movement can be better defined.

### Needle Tracking Strategy:

Another advantage of multiple sensors is that during a biopsy/therapy procedure, a sensor may be attached to the biopsy/therapy needle (e.g. at the base of the needle or introducer) so the needle trajectory is tracked during the operation process. The calibration of the needle with sensor will be done prior to the procedure and is similar to the calibration discussed above. Specifically, once a tracker is attached to the needle the extra pointer sensor 22 marks points (such as the needle tip). That is various needle locations are measured using the extra pointer (e.g., needle tracker/pointer 22; see FIG. 4A) and the needle sensor location is given at the same time. The transformation matrix between the tracker pointer (e.g. needle tip) and the needle sensor can be determined. Supposing the needle sensor location is Pₙ, and the tracker pointer measured location is Pₜ. The distance between the needle tip and the tracker pointer is D. The location of the tip can be calculated as:

$$\begin{matrix}{P}_{tip} = {T}_{c} \cdot {T}_{t - s} \cdot {P}_{sensor} \\ Where & ( 7 ) \\ {T}_{t - s} = [ \begin{matrix}1 & 0 & 0 & D \\ 0 & 1 & 0 & 0 \\ 0 & 0 & 1 & 0 \\ 0 & 0 & 0 & 1 \end{matrix} ] & ( 8 )\end{matrix}$$

Tₜ₋ₛ can be different depending on how the tracker sensor is installed on the needle. Accordingly, by tracking the tracker on the needle (e.g. at the need base) the tip position of the needle may be identified and displayed.

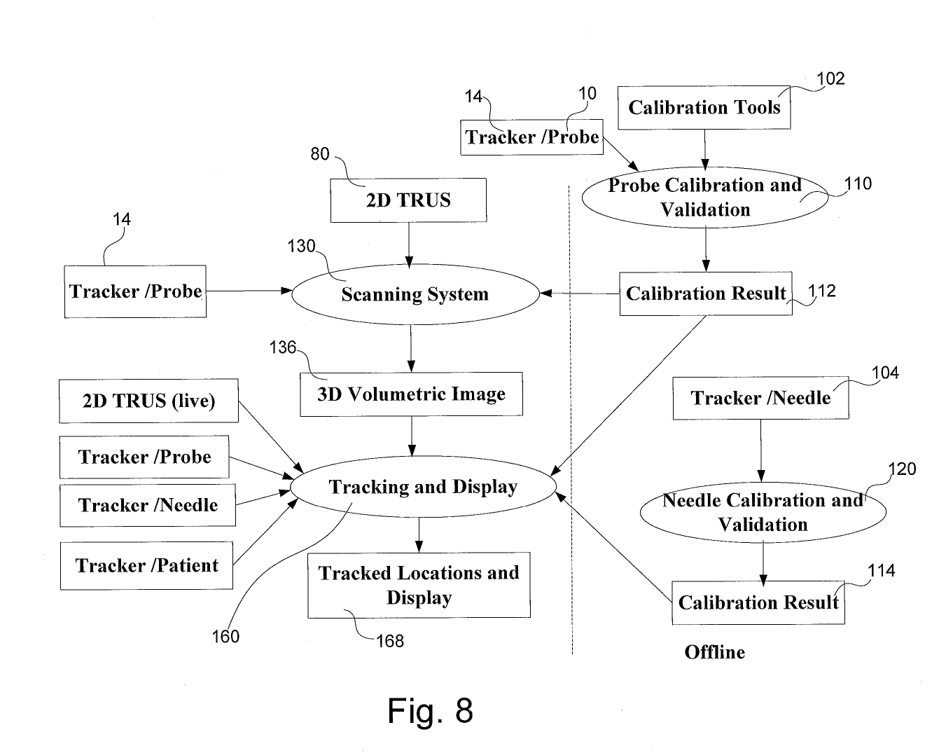

FIGS. 8-16 illustrate various process flow sheets and/or computer implementable algorithms that may be implemented in the freehand tracking system described above. FIG. 8 is an overview of the entire tracking system. As shown, portions of the overall system may be performed offline (e.g., prior to a patient procedure) such that an ultrasound probe is calibrated for images acquired during a procedure and/or a needle insertion device is calibrated prior to use during a real time procedure. As shown, during the offline procedure, various calibration tools 102 are utilized with a probe 10 that includes a tracker 14 as described above. Inputs from calibration tools 102 and the tracker/probe 10 are input to the probe calibration and validation process 110 in order to provide calibration results 112 that allow for determining the position of an ultrasound image plane in a three-dimensional frame of reference. Likewise, when a needle is calibrated, the needle tracker 104 information is input to the needle calibration and validation process 120 in order to provide calibration results 114. As noted above, such calibration results may include offsets or matrices that allow for determining the position of, for example, an image plane and/or needle tip relative to a three-dimensional frame of reference.

During the online portion of the procedure, two-dimensional ultrasound images/image planes 80 are acquired utilizing a two-dimensional imaging system 122. Such a scanning system utilizes, for example, a two-dimensional transrectal ultrasound system that incorporates the tracker/probe 10 as well as the predetermined calibration results 112. Such a system may be operative to generate a three-dimensional volumetric image where the freehand two-dimensional images 80 are arranged into a three-dimensional space and/or interpolated to generate a three-dimensional volumetric image 136. Once such a three-dimensional image is generated, various tracking and display processes 160 may be performed. In this regard, information within the three-dimensional image may be tracked in real time to provide an output of tracked locations on a display 168. In order to provide updated and real time tracking and display, the process may receive live ultrasound images, information from the tracker/probe, information from the tracker needle, and/or information from a tracker interconnected to a patient.

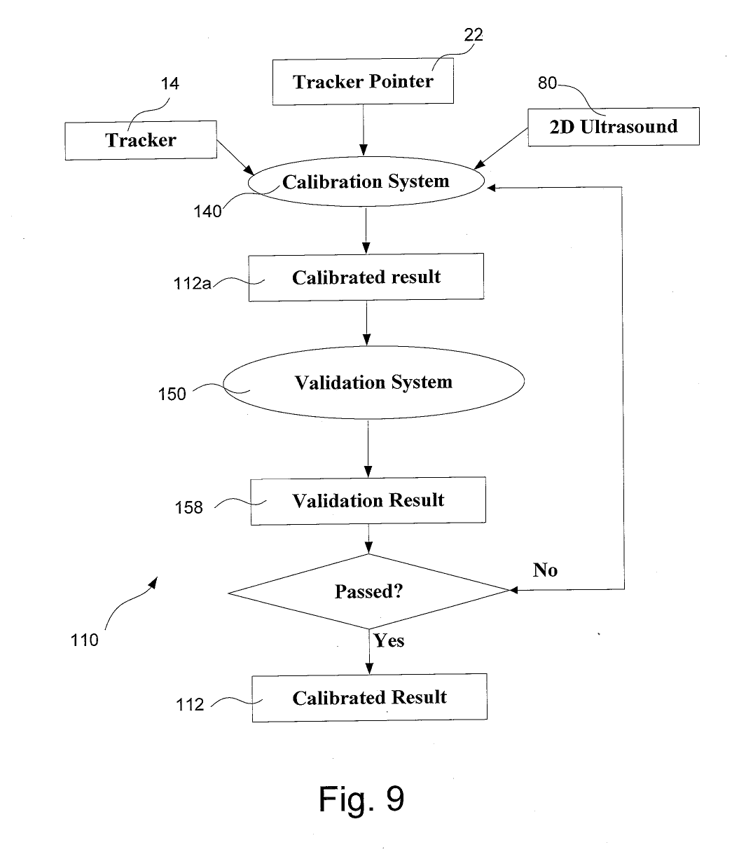

FIG. 9 illustrates the probe calibration and validation process 110. Generally, the system calibrates the tracker utilizing another tracker pointer. In this regard, a tracker 14, which may be interconnected to the ultrasound probe 10, generates a location output that is provided to the calibration system 140. Likewise, a tracker pointer 22 is utilized to provide input to the calibration system 140. As noted above, this process may entail aligning an ultrasound image plane 80 to identify a point therein and simultaneously touching that point with the track needle 22. Accordingly, the calibration system generates preliminary calibrated results 112a. This preliminary calibrated result 112a is provided to a validation system 150 to determine the validity of the calibration. That is, the validation system provides a validation result 158, which must pass a predetermined threshold. Otherwise, the system iterates until the validation result passes the threshold and generates the final calibrated result 112.

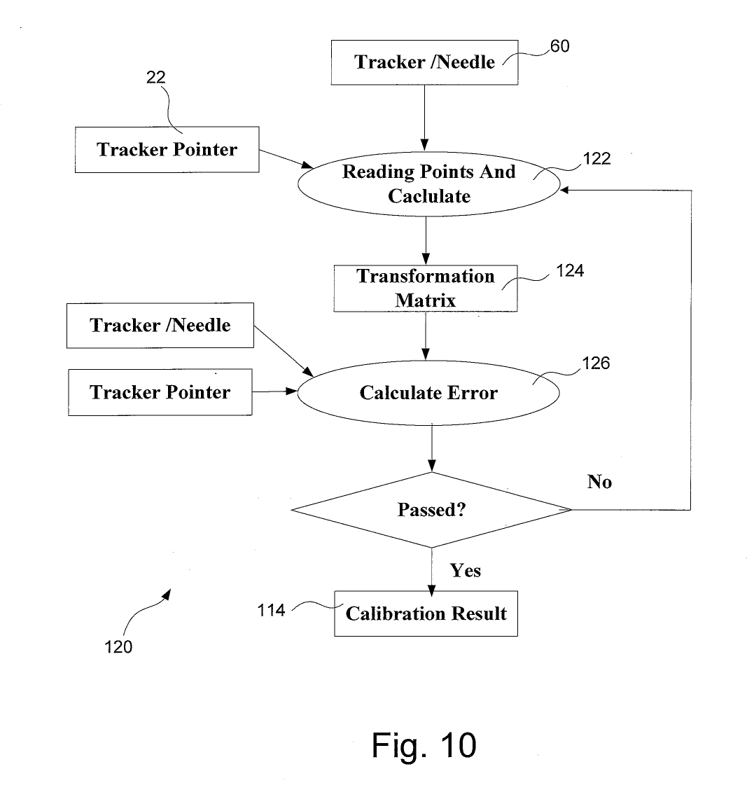

FIG. 10 illustrates a needle calibration and validation process 120. Initially, the process 20 receives information from a tracker needle assembly 60 and the tracker pointer 22. As described above, the process 120 utilizes these points to calculate 122 a transformation matrix 124 that allows for identifying, for example, the position of a needle tip within a three-dimensional space or image volume. Additional inputs may be received from the tracker needle and/or tracker pointer to calculate an error 126. Again, such repeated calculations may be generated until a calibration result 114 is generated that passes a predetermined threshold. Stated otherwise, the needle calibration allows for a tracker to be attached to a needle (e.g., the base of a needle) such that a location of the needle tip may be measured by the tracker pointer 22. The transformation matrix from the needle tracker to the pointer is calculated, and the system is validated by calculating the error from the pointer reader. If acceptable, the calibration is accepted.

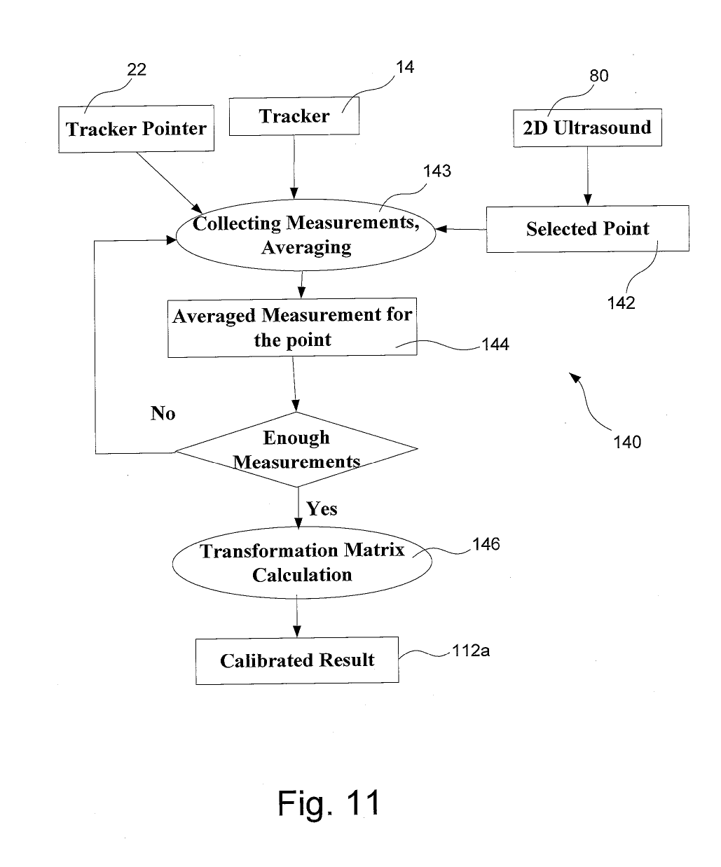

FIG. 11 illustrates the calibration system 140, noted above in relation to FIG. 9. As shown, a number of points are measured using the tracker pointer, and based on the two-dimensional coordinates inside the two-dimensional images, a calibration matrix is calculated. Specifically, a two-dimensional image 80 is provided, and a point within that image 142 is selected. The tracker pointer 22 is utilized to touch the physical point illustrated in the ultrasound image 80. This may be repeated multiple times for the selected point in order to generate an average measurement for the point 142. Once enough measurements are made for a particular point, the transformation matrix is calculated 146. As noted in relation to FIG. 9, this generates the preliminary calibrated result 112a.

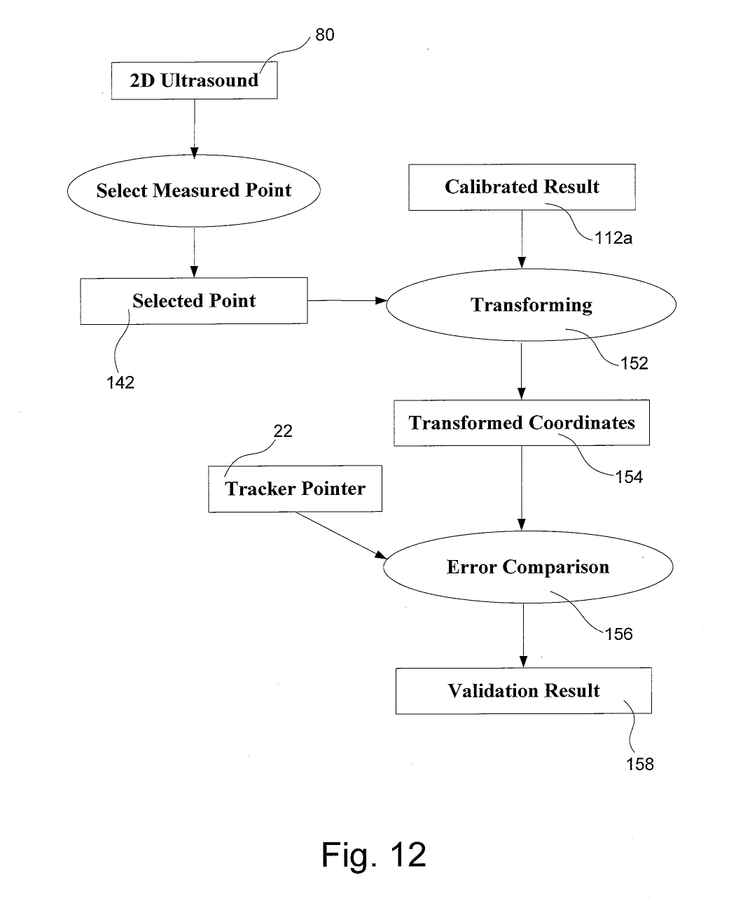

FIG. 12 illustrates a validation system 150, as discussed in relation to FIG. 9. Generally, the validation system compares the tracker pointer output and calculated coordinates utilizing the calibrated transformation matrix to determine the validity of the results. Again, the validation system 150 utilizes the two-dimensional ultrasound images/planes 80 provided by the probe 10 and identifies a selected point 142. The validation system utilizes the preliminary calibrated result 112a to transform 152 the selected point into transform coordinates 154. At such time, the point from the image plane 142 should match the coordinates of the tracker pointer for that point. That is, the tracker pointer 22 location is compared to the transform location of the selected point 142 to determine an error comparison 156. This generates the validation result 158, as noted in relation to FIG. 9.

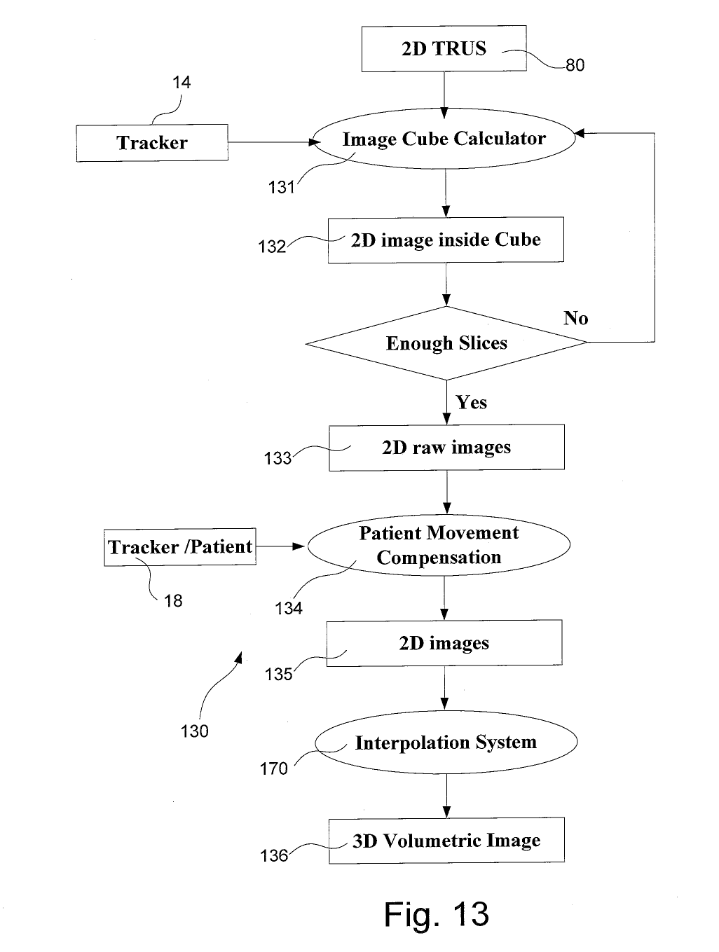

FIG. 13 provides an overview of the scanning system where the freehand image planes are disposed in a common frame of reference or image cube that allows interpolation of the multiple planes in the image cube to generate a three-dimensional volumetric image. As shown, the scanning system 130 receives two-dimensional images 80 from the probe 10 and location information from the tracker 14. These are input to the image cube calculator 131 in order to generate a two-dimensional image inside the cube 132. This is repeated until a user determines that enough image slices are acquired. At such time, the system has acquired as a set of two-dimensional raw images 133. Information may likewise be obtained from a patient tracker 18 to account for patient movement during the scanning procedure. Stated otherwise, each two-dimensional raw image may be compensated 134 for patient movement to generate a set of compensated two-dimensional images 135. Such compensated images may be provided to the interpolation system 170 that allows for filling in voids or gaps between image data to generate the three-dimensional volumetric image 130.

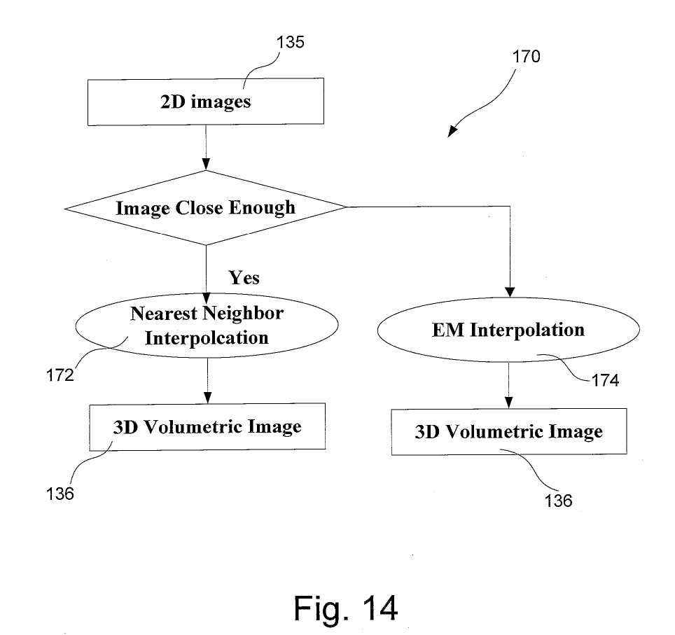

FIG. 14 illustrates one embodiment of an interpolation system 170 that allows for interpolating images utilizing two separate interpolation schemes based on the density of the acquired data. Initially, the compensated two-dimensional images 135 are provided, and a determination is made if the image information is dense enough to utilize a nearest neighbor interpolation scheme 172. If so, pixels between known data pixels are interpolated to generate the three-dimensional volumetric image 136. However, if a determination is made that the image data is too sparse for nearest neighbor interpolation, such information may be provided to an EM interpolation system 174 to provide a more robust interpolation. Such an EM interpolation system is set forth in U.S. patent application Ser. No. 12/695,822, as incorporated above. Again, if such information is provided to the EM interpolation processor 174, the result is a three-dimensional volumetric image 136.

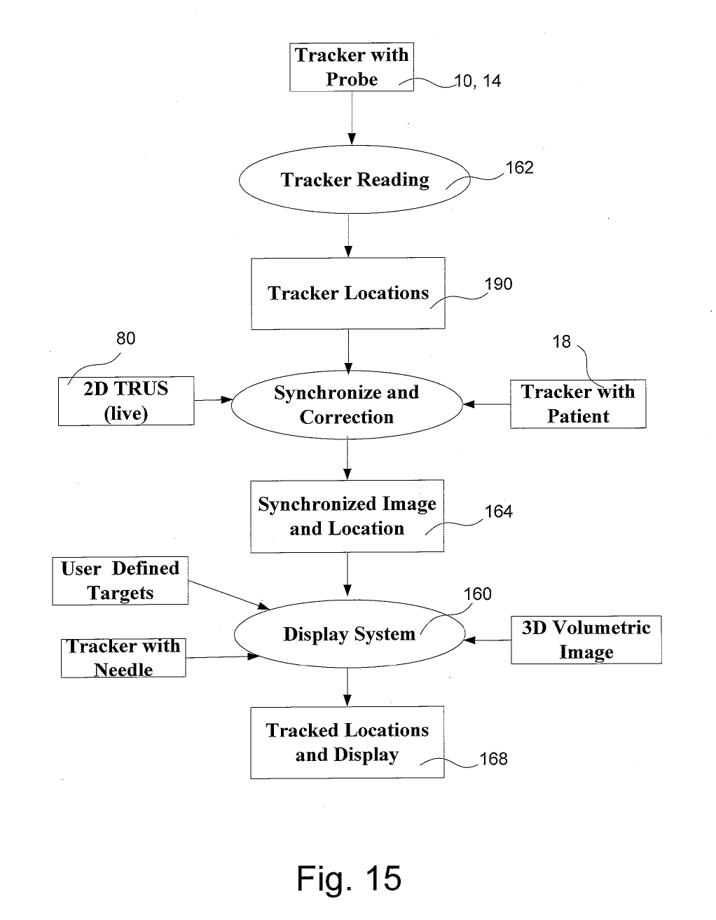

FIG. 15 illustrates the tracker and display process. Generally, the tracker location is read using averaging, and the input ultrasound image is synchronized. Based on the location of the tracker, the three-dimensional volumetric image may be displayed, and a user-defined target may be tracked. Specifically, the tracker 14 with the probe 10 provides tracker locations 162, and these tracker locations are provided to the synchronizer 164 in conjunction with the two-dimensional images 80 and/or tracker information from the patient 18. The synchronizer utilizes this information to provide a synchronized image and location 164, which is provided to the display system and incorporated into the three-dimensional volumetric image 136 with user-defined targets and/or needle position of a needle with a tracker. These locations are displayed in real time 168.

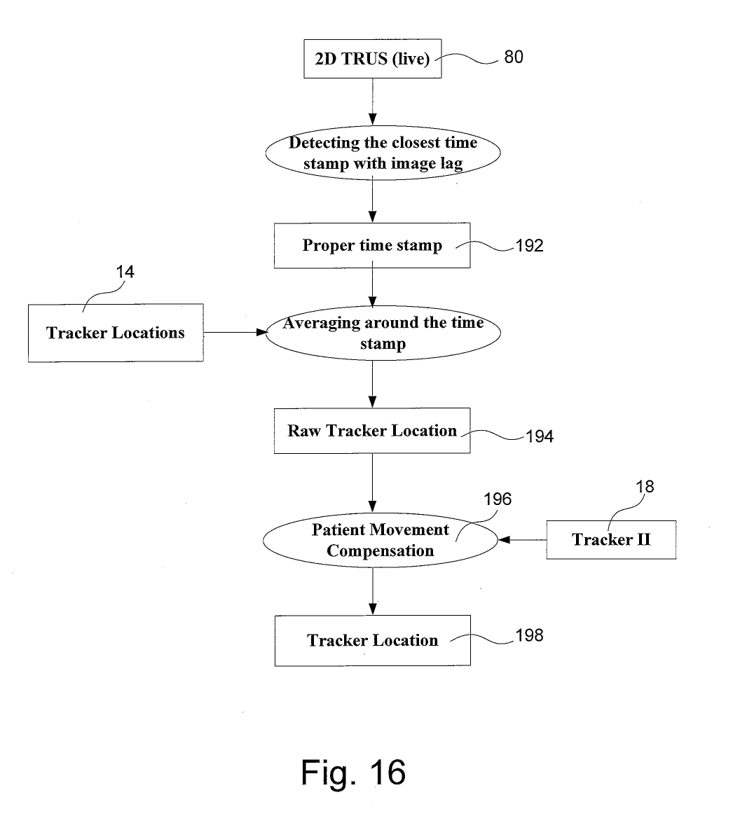

FIG. 16 illustrates the synchronization and correction process 190 of FIG. 15. Again, live two-dimensional ultrasound images 80 are acquired and associated with a time stamp 192. The tracker locations 14 are also acquired. As noted in relation to FIG. 7, due to the different sampling rate of the tracker and the ultrasound system, it is desirable to average a number of these readings about a particular time. In this regard, it is desirable to average around the time stamp of the live image in order to minimize errors. This results in generating a raw tracker location 194, which may be compensated for patient movement 196 utilizing a patient mounted tracker 18. As a result, a synchronized and corrected tracker location 198 is generated and may be utilized to synchronize image locations.

Generally, the above-noted system allows for acquiring multiple individual ultrasound image planes and reassembling those multiple individual image planes into a common frame of reference and subsequently utilizing the combined information of these images to generate a three-dimensional volumetric image in which one or more points of interest and/or needles may be tracked (e.g. in real time). Further, such a system may be applicable for use with existing two-dimensional ultrasound machines. In this regard, all that is required is that a tracker 14 be securely affixed to an ultrasound probe prior to calibration. However, it will be appreciated that various ultrasound probes may have built in trackers for use with the system without, for example, utilizing a separate tracker interconnected to the probe.

We claim:

1. A method for calibrating a 2D image plane of an ultrasound probe to a 3D coordinate system and using said probe to acquire images, comprising:
positioning an ultrasound probe in a first position relative to a phantom, wherein a calibration point of said phantom is displayed in a first 2D image plane output by said ultrasound probe
measuring a first 3D position and orientation of the ultrasound probe relative to said 3D coordinate system;
determining a 3D position of said calibration point of said phantom relative to said 3D coordinate system using a pointer tracker;
computing an image plane calibration matrix based on the first position and orientation of the ultrasound probe and the 3D position of said calibration point, wherein said calibration matrix translates pixels in said 2D image plane into said 3D coordinate system.

2. The method of claim 1, wherein said first and second measuring steps are performed while said ultrasound probe is maintained in a fixed positional relationship to said calibration point.

3. The method of claim 1, wherein computing said image plane calibration matrix further comprises:
repositioning the ultrasound probe in a second position and orientation relative to the phantom, wherein said calibration point is displayed in a second 2D image plane output by said ultrasound probe;
measuring the second position and orientation of the ultrasound probe relative to said 3D coordinate system;
re-determining a 3D position of said calibration point of said phantom relative to said 3D coordinate system using said pointer tracker.

4. The method of claim 3, further comprising performing a plurality of repositioning, measuring and re-determining steps to obtain a plurality of measured values for use in computing said calibration matrix.

5. The method of claim 1, wherein measuring a first 3D position of said ultrasound probe comprises measuring a position of an electromagnetic sensor attached to said probe relative to an electromagnetic field.

6. The method of claim 5, wherein determining said 3D position of said calibration point comprises touching said calibration point with an electromagnetic sensor of said pointer tracker.

7. The method of claim 1, further comprising:
after generating said calibration matrix, positioning a patient within said 3D coordinate system; and
acquiring a plurality of 2D image planes using said ultrasound probe;
transforming said plurality of 2D image planes using said calibration matrix, wherein pixel information from said 2D image planes is transformed into said 3D coordinate system and populates an image cube.

8. The method of claim 7, further comprising:
upon populating said image cube, interpolating data between known pixels to generate a 3D image.

9. The method of claim 1, further comprising:
positioning a needle body in a first position relative to said phantom, wherein a tip of said needle touches said calibration point of said phantom;
measuring a first 3D position and orientation of an electromagnetic tracker fixedly attached to a proximal portion of said needle body;
determining a 3D position of said calibration point of said phantom relative to said 3D coordinate system using a pointer tracker; and
computing a needle tip calibration matrix based on the first position and orientation of the electromagnetic tracker and the 3D position of said calibration point, wherein said calibration matrix identifies a 3D position of said needle tip in said 3D coordinate system.

10. A method for calibrating a needle to a 3D coordinate system, comprising:
positioning a needle body in a first position relative to a phantom, wherein a tip of said needle touched a calibration point of said phantom;
measuring a first 3D position and orientation of an electromagnetic tracker fixedly attached to a proximal portion of said needle body;
determining a 3D position of said calibration point of said phantom relative to said 3D coordinate system using a pointer tracker;
computing a needle tip calibration matrix based on the first position and orientation of the electromagnetic tracker and the 3D position of said calibration point, wherein said calibration matrix identifies a 3D position of said needle tip in said 3D coordinate system.

11. The method of claim 10, wherein computing said needle tip calibration matrix further comprises:
repositioning the needle body in a second position and orientation relative to the phantom, wherein said needle tip touches a second calibration point;
measuring the 3D second position and orientation of the electromagnetic tracker attached to said needle body;
determining a 3D position of said second calibration point of said phantom relative to said 3D coordinate system using said pointer tracker.

12. The method of claim 11, further comprising performing a plurality of repositioning, measuring and determining steps to obtain a plurality of measured values for use in computing said calibration matrix.

13. The method of claim 10, further comprising:
obtaining a tissue image output from an ultrasound probe, wherein said tissue image output is displayed in relation to said 3D coordinate system; and
displaying a location of said needle tip in said image output.

14. The method of claim 13, further comprising:
using said image output to guide said needle tip to a desired tissue location.

15. A system for calibrating the location of ultrasound images to a 3D reference coordinate system, comprising:
an ultrasound probe for use in acquiring ultrasound data and generating output images;
an electromagnetic tracker attached to said ultrasound probe, the position and orientation of said electromagnetic tracker being trackable relative to a 3D reference coordinate system by an electromagnetic tracking sensing system; and
a tracker pointer having an electromagnetic tracker tip positionable relative to an identified point; and
a processor, being operative to:
receive output images from said ultrasound probe;
receive 3D position and orientation information of said electromagnetic tracker and 3D position information from said electromagnetic tracker tip from said tracking system; and
compute an image calibration matrix based on the 3D position and orientation of the electromagnetic tracker and the 3D position information from said tracker pointer when said tracker tip is touching a point within one of said output images, wherein said calibration matrix translates pixels in said output images into said 3D coordinate system.

16. The system of claim 15, further comprising:
a mount for supporting the electromagnetic tracker relative to a housing of said ultrasound probe.

17. The system of claim 1, wherein upon calculating said calibration matrix said processor is further operative to:
obtain images from said ultrasound probe;
transform said images into said 3D reference coordinate system;
populate an image cube with information form a plurality of transformed images; and
generate an output display of said image cube.

18. The system of claim 17, wherein said processor is further operative to:
interpolate said image cube to generate a 3D image.
